(19) United States
(12) Patent Application Publication
(10) Pub. No.: US 2008/0073399 A1
(43) Pub. Date: Mar. 27, 2008

(54) Lighter socket pen holder

(76) Inventor: David Rosenblum, West Long Branch, NJ (US)

Correspondence Address: PAUL R. MARTIN, 5333 BAYRIDGE COURT, FAIRFIELD, CA, 94534, US

(21) Appl. No.: 11/528,125

(22) Filed: Sep. 26, 2006

(51) Int. Cl. B60R 11/00; B60R 7/00

(52) U.S. Cl. 224/544

(57) ABSTRACT

A writing instrument holder is inserted into an automotive cigarette lighter socket or receptacle. The holder includes a cylindrical body with a cylindrical or elongated cavity that receives one end of the writing instrument. The holder has an end flange with an opening communicating with the cavity. The opening in the end flange is preferably narrower than the cavity diameter, and may be surrounded by spaced projections or slits to more easily accept instruments of different diameters. Alternately, a plurality of spaced grippers may extend inwardly from the body around the cavity.

### BACKGROUND OF THE INVENTION

The invention relates generally to holders, and more particularly holders for use in motor vehicles, and most particularly to holders that are mounted in the cigarette lighter sockets in a motor vehicle.

Drivers and passengers in motor vehicles often desire to have various articles available for use while in the vehicle. Generally, easy access is important, particularly for the driver, to avoid distraction from the road while the vehicle is in operation. Thus, a number of different holders for various articles have been developed for use in a motor vehicle. Cup holders, for one, have proven to be particularly useful. Various holders also clip onto the visor.

Most motor vehicles include removable or pop-out cigarette lighters. The lighter sockets are typically built into the dashboard or a console or sometimes into an armrest in a door. A variety of holders designed to fit into automotive lighter sockets have been developed.

U.S. Pat. No. 4,205,367 to Arnold III shows a cigarette lighter holder constructed to fit into a conventional motor vehicle lighter socket. A lighter housing adapter sleeve is inserted into the socket. The sleeve is preferably made of rigid nonconductive molded plastic or rubber and has a generally circular cylindrical cross section conforming to the inside of the socket. A flared collar extends from the holder to cover the socket edges. A butane gas lighter or the like fits into the holder.

U.S. Pat. No. 4,877,164 to Baucom shows a cup holder with an expandable plug mounting means that fits into a cigarette lighter receptacle in a vehicle. The mounting means is formed of a hollow cylindrical member adapted to fit snuggly within the lighter opening. An articulated arm extends from the plug.

U.S. Pat. Nos. 5,048,733; 5,086,958; and Des.388,762 to Nagy show automotive accessory mounts with cylindrical bases that fit into a cigarette lighter receptacle. A rod to which the accessory support is mounted extends out from the base.

U.S. Pat. No. 5,489,055 to Levy shows an automotive cup holder that is mounted in a lighter socket by an elongated support cylinder.

U.S. Pat. No. 6,202,345 to Wokal shows a support structure for attachment to an automotive cigarette lighter receptacle. The holder has a support member with an end that is sized to fit into the lighter socket and a support member attached, generally perpendicular, to the support member.

U.S. Pat. Des. 358,707 to Holt shows a combined sunglass holder and insert for an automobile lighter receptacle.

One particular article that occupants of a motor vehicle often need is a writing instrument. Thus a simple holder designed specifically for a pen or pencil or other writing instrument is desired.

### SUMMARY OF THE INVENTION

Accordingly it is an object of the invention to provide a simple holder for a writing instrument that mounts in a motor vehicle lighter socket.

It is also an object of the invention to provide a holder that easily accepts instruments of different diameters.

The invention is a writing instrument holder or gripping device that is inserted into an automotive cigarette lighter socket or receptacle. The holder includes a cylindrical body with a cylindrical or elongated cavity that receives one end of the writing instrument. The holder has an end flange with an opening communicating with the cavity. The opening in the end flange is preferably narrower than the cavity diameter, and may be surrounded by spaced projections or slits to more easily accept instruments of different diameters. The cavity may alternately be surrounded by spaced grippers or restrictions extending therein.

### BRIEF DESCRIPTION OF THE DRAWINGS

In the accompanying drawings:

FIG. 1 is a perspective view of a holder of the invention with a writing instrument inserted therein.

FIG. 2 is a perspective cross-sectional view of a holder of the invention with a writing instrument inserted therein.

FIG. 3 is a cross-sectional side view of a holder of the invention mounted in a lighter socket.

FIG. 4 is a cross-sectional side view of an alternate embodiment of a holder of the invention.

FIGS. 5A-C are end views of alternate embodiments of a holder of the invention.

FIG. 6 is a cross-sectional side view of another alternate embodiment of a holder of the invention.

### DESCRIPTION OF THE INVENTION

As shown in FIGS. 1-2, a writing instrument holder or gripping device 10 of the invention has a substantially cylindrical body 16 with a flange 14 at one end thereof. Cylindrical body 16 defines a substantially cylindrical cavity 22 therein. A writing instrument 12 is received in and held in the cavity 22 of the holder 10. (More specifically, a portion of the instrument 12 extends into the holder 10 while a portion extends out. Instrument 12 may be inserted and removed as desired.)

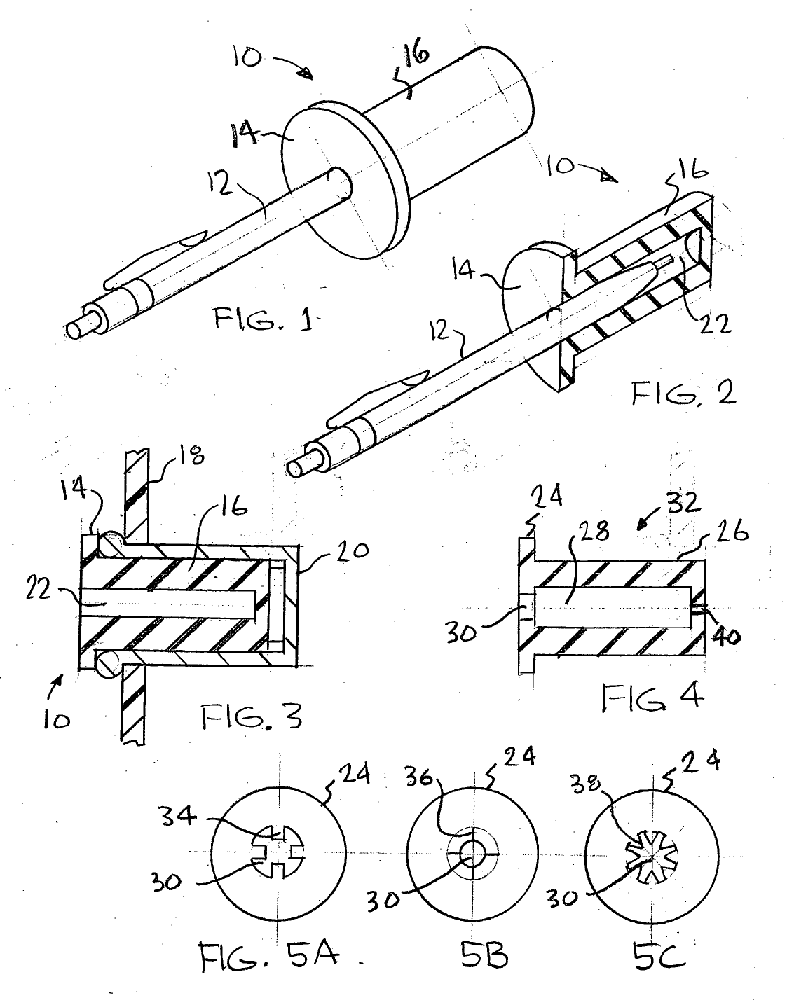

In operation, as shown in FIG. 3, holder 10 is placed in a lighter socket or receptacle 20 that is mounted on the dashboard (or other) structure 18 of a motor vehicle. The distal end of holder 10 from flange 14 is inserted into socket 20 and holder 10 is pushed into the socket 20 until the flange 14 is substantially flush with the outer edge of socket 20. Body 16 of holder 10 has a suitable length and diameter so that it fits snuggly into the socket 20. Body 16 is preferably made of rubber or other flexible material so that it can be easily press fit into the socket and will be held therein. The material should be thermally stable and electrically nonconductive.

As shown in FIG. 3, cavity 22 extends though the end flange 14 of holder 10 so that a writing instrument may be inserted. However, only instruments of the same diameter as the cavity 22 can be held snuggly therein. Instruments with a smaller diameter will fit loosely and are likely to fall out while instruments with a larger diameter will not fit at all.

FIG. 4 shows an alternate embodiment of the invention that is designed to accept writing instruments of different diameters. Holder or gripping device 32 is similar to holder 10 in having a substantially cylindrical body 26 with an internal cavity 28 and an end flange 24. However, cavity 28 has a greater diameter than cavity 22 so that it can accommodate writing instruments of various diameters. Flange 24 has an opening 30 therein that has a smaller diameter than cavity 28. Holder 32 can accept instruments of different diameters since the portion of end flange 24 surrounding the opening 30 and overlapping the cavity 28 is sufficiently thin and pliant so that instruments of different diameters can be pushed through the opening 30. A small opening 40 may be formed in the distal end of holder 32. This facilitates insertion and removal of the holder from the socket.

The simple circular opening 30 allows writing instruments of different diameters to be more easily inserted into the holder 32. However, depending on the diameter of the instrument, it still can be somewhat difficult to insert the instrument because all the material around the opening 30 must be compressed.

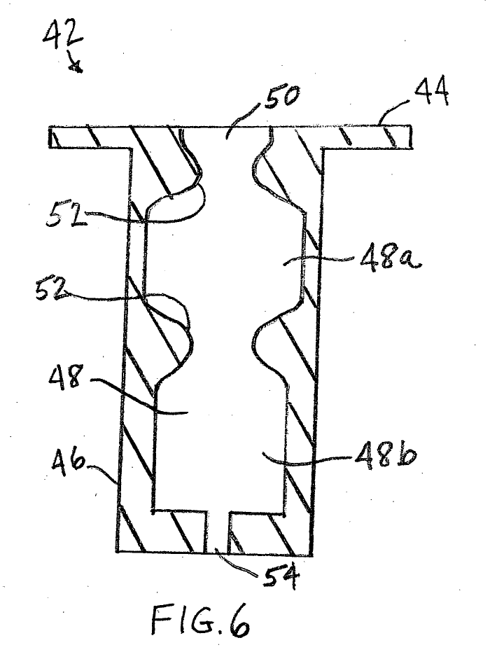

FIGS. 5A-C show some modifications to permit easier insertion of instruments of different diameters by providing greater flexibility around the opening 30 in flange 24. In FIG. 5A, a plurality of small spaced rectangular projections 34 surround the opening 30. In FIG. 5B, a plurality of spaced slits 36 extend into the material of flange 24 around the opening 30 to create a plurality of flaps. In FIG. 6C, a plurality of small spaced triangular projections 38 surround the opening 30. In these alternate embodiments, the portion of end flange 24 surrounding the opening 30 (and overlaying the internal cavity) yields more easily to the pressure of inserting a writing instrument because of its segmented structure.

FIG. 6 shows another embodiment of the invention designed to accept and firmly hold writing instruments of different diameters. Holder or gripping device 42 is similar to holders 10 and 32 in having a substantially cylindrical body 46 with an internal cavity 48 and an end flange 44. Flange 44 has an opening 50 therein that has a generally smaller diameter than the cavity 48. A plurality of spaced restrictions or projections or grippers 52 are formed on the inside wall of body 46, extending into the cavity 48. As shown, there are two grippers 52, one near the opening 50 and the other further into the cavity 48. The spaced grippers 52 extend inwardly from body 46 around the cavity 48 and divide cavity 48 into sections (48a, 48b) which may have the same or different diameters. Grippers 52 are rings or bands of the flexible body material and are sufficiently thin and pliant so that writing instruments of different diameters can be pushed into cavity 48 through the grippers 52, which will firmly hold the instrument. A small hole 54 may be formed in the end of holder 42.

Accordingly, a holder has been provided that mounts in the lighter socket of a vehicle and easily holds and releases various writing instruments, i.e. pens, pencils or the like, or other similarly shaped narrow cylindrical articles.

Changes and modifications in the specifically described embodiments can be carried out without departing from the scope of the invention which is intended to be limited only by the scope of the appended claims.

1. A holder that is inserted into a lighter socket or receptacle of a motor vehicle, the holder comprising:
a substantially cylindrical body having a substantially elongated cavity therein and having a length and diameter to fit snuggly within the socket or receptacle;
an end flange at one end of the cylindrical body and having an opening therein that communicates with the cavity;
whereby a portion of a writing instrument or other cylindrical article may be inserted through the opening and be releasably held within the cavity.

2. The holder of claim 1 wherein the opening in the end flange has a diameter that is narrower than the diameter of the cavity.

3. The holder of claim 2 further comprising a plurality of spaced projections or slits surrounding the opening in the flange to facilitate insertion of the instrument through the opening.

4. The holder of claim 1 further comprising a plurality of spaced grippers extending inwardly from the body around the cavity.

5. The holder of claim 1 wherein the body and flange are made of rubber or other flexible material.
